(19) United States
(12) Patent Application Publication
(10) Pub. No.: US 2007/0130396 A1
(43) Pub. Date: Jun. 7, 2007

(54) A COMPUTER I/O DEVICE WITH A VOICE I/O UNIT

(75) Inventors: Wei-Chih Yen, Chung Ho, Taipei County (TW); Yun-Chen Fu, Chung Ho, Taipei County (TW)

Correspondence Address: PAI PATENT & TRADEMARK LAW FIRM, 1001 FOURTH AVENUE, SUITE 3200, SEATTLE, WA, 98154, US

(73) Assignee: SYSGRATION LTD., Chung Ho, Taipei County (TW)

(21) Appl. No.: 11/164,006

(22) Filed: Nov. 7, 2005

(51) Int. Cl. G06F 13/38

(52) U.S. Cl. 710/62

(57) ABSTRACT

A computer I/O (input/output) device with a voice I/O unit comprises a voice I/O unit and an I/O device, wherein said voice I/O unit is coupled with said I/O device having a capability of either a mouse, a keyboard or other computer peripheral devices through a hardware or software configuration. Said voice I/O unit also works with an instant messenger to allow a user to operate said computer I/O device as usual or to conduct online communication or VoIP (Voice over IP) capabilities if necessary.

### BACKGROUND OF THE INVENTION

1. Field of the invention

The present invention relates to a computer I/O (input/output) device with a voice I/O unit and more particularly to a computer peripheral device having a capability of either a mouse, a keyboard or other computer peripheral apparatus, coupled with a voice I/O unit to control both computer I/O function and voice I/O function to facilitate the use of instant messenger (IM) and to improve online communications.

2. Description of the Prior Art

As the Internet becomes more popular, surfing the Internet has now become part of everyday life for most people. In addition to tapping its huge resources for data searching needs, a large number of Internet surfers are obsessed with the far reaching networking environment for making friends online using popular instant messengers (IMs) such as Skype, MSN, ICQ, QQ, Yahoo and Net2 phone, etc. Fueled by the increasing network bandwidth, now it is more viable to exchange voice messages and photos/graphics on the Internet, which further stimulates the adoption of network phone and video conference. Since the Internet has vastly and profoundly changed our daily lives, the aim to exploit the Internet to let its users enjoy the convenience that it brings has consequently improved and enhanced the function of related software and hardware infrastructure.

In order to use IM on the Internet, the first step is to establish a complete hardware and software infrastructure, such as basic computer device and voice I/O unit, along with software-based Internet connection tool, IM software and VoIP (Voice over IP) software such as Skype, etc. Although it is not difficult for common users to install these tools, too many externally connected devices will somehow affect the convenience in using IM. For example, a network user usually uses only computer I/O devices such as mouse and keyboard in operating the PC, when there's an incoming VoIP call, he/she will use the computer I/O devices to choose whether to answer the call, then use an earphone and microphone to conduct voice communication. Preferably, combining a computer I/O device with a voice I/O unit will simplify the process for the user to establish communication sessions with other IM users and further improve the usability of desktop space.

### SUMMARY OF THE INVENTION

It is an object of the present invention to provide a computer I/O device with a voice I/O unit to provide computer I/O function and VoIP function with one single interface to improve the capability of the device.

It is another object of the present invention to provide a computer I/O device with a voice I/O unit, which simplifies the process for the user to establish communication sessions with other IM users and enhances the interactive experience with friends online.

It is another object of the present invention to provide a computer I/O device with a voice I/O unit, which works with instant messengers such as MSN, ICQ, QQ, Yahoo, and Net2 phone to enable easy-to-use operations.

It is still another object of the present invention to provide a computer I/O device with a voice I/O unit, wherein the voice I/O unit can be used independently such as for listening to music.

To achieve the above-mentioned objects, the present invention discloses a computer I/O device with a voice I/O unit comprising a voice I/O unit and an I/O device, wherein the voice I/O unit is coupled with the I/O device having a capability of either a mouse, a keyboard or other computer peripheral devices through a hardware or software configuration. The voice I/O unit also works with an instant messenger for allowing a user to operate the computer I/O device as usual or to conduct online communication or VoIP (Voice over IP) capabilities if necessary. Furthermore, the computer I/O device with the voice I/O unit is easy to operate, allowing average users to use functions of either the computer I/O device or the voice I/O device, or both.

### BRIEF DESCRIPTION OF THE DRAWINGS

The drawings disclose a preferred embodiment of the present invention which serves to exemplify the various advantages and objects hereof, and are as follows:

FIG. 1 illustrates a structural configuration of the present invention; and

FIG. 2 illustrates a device structure of the present invention.

### DETAILED DESCRIPTION OF THE PREFERRED EMBODIMENT

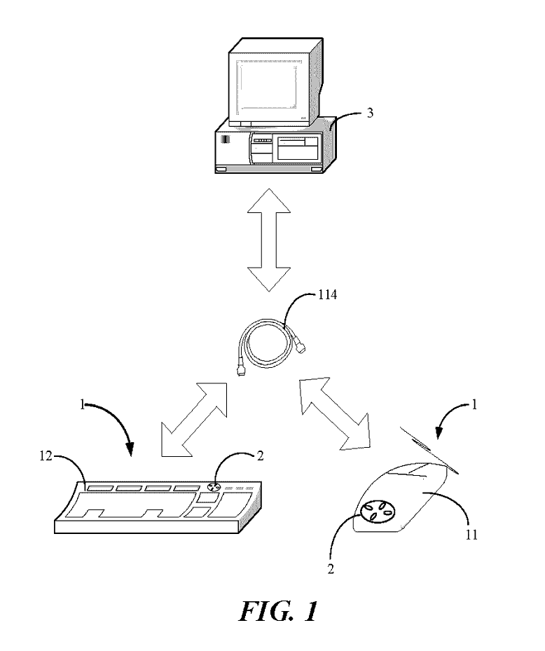

Please refer to FIG. 1, which illustrates a structural configuration of a computer I/O device with a voice I/O unit. The device comprises an I/O device 1, which can be a mouse 11 or a keyboard 12, or other computer peripheral devices having I/O capabilities. In one embodiment, the I/O device 1 is a mouse 11, which comprises a voice I/O unit 2 coupled with the I/O device 1 through a hardware or software configuration, allowing the I/O device 1 to enable/disable the voice I/O unit 2 or to adjust the sound volume of the voice I/O unit 2.

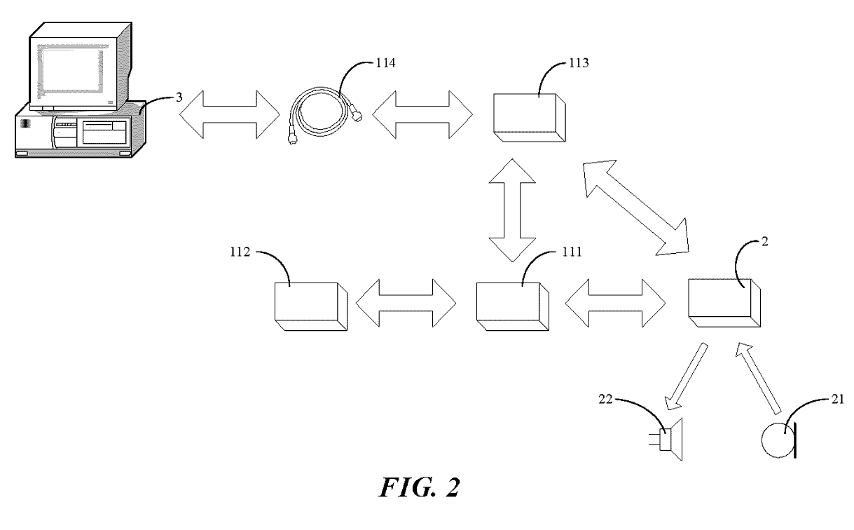

FIG. 2 illustrates a device structure of the present invention. In one embodiment, a mouse 11 is implemented as the I/O device 1. The mouse 11 comprises a central processing unit (CPU) 111, which is coupled to a control module 112. The control module 112 is used for sensing and receiving data sent from every control button of the mouse 11. The CPU 111 is also coupled to a computer 3 through an I/O port 113 via a transmission interface 114 to exchange data with the computer 3, wherein the transmission interface 114 can be a wired transmission interface such as USB and IEEE 1394 or a wireless transmission interface such as Bluetooth or Infrared. In one embodiment, the voice I/O unit 2 generally comprises a microphone 21 and a speaker 22, both controlled by the CPU 111, for sending voice signals via the I/O port 113 and the transmission interface 114 to the computer 3 or for the computer 3 to send voice signals to the speaker 22 for sound broadcasting. Furthermore, the control module 112 can transmit a control signal of the mouse 11 to the CPU 111, using a hardware or software control scheme to enable/disable the voice I/O unit 2 or to adjust the sound volume of the voice I/O unit 2.

The mouse 11 in the present invention generally acts as a normal mouse, however, when there's an incoming VoIP call, the user can press a preset button on the mouse 11 to use the mouse 11 as a speaker phone; or when the user picks up the mouse 11, a motion sensor at the bottom of the mouse 11 will detect that the mouse 11 has been picked up, and then a built-in hardware- or software-based switch will be triggered to switch the mouse 11 to a normal handset mode. Meanwhile, the sound volume of the microphone 21 and the speaker 22 can be adjusted automatically to work with the handset or speaker phone functions.

Therefore, the present invention combines voice I/O unit 2 with I/O device 1 into a single device, which only uses one I/O port to save space for chassis. The user can simply use either the computer I/O function or the voice I/O function, or both. When VoIP capabilities are not in use, the user can use the speaker 22 for music playback or use an externally connected speaker to listen to music.

Many changes and modifications in the above described embodiment of the invention can, of course, be carried out without departing from the scope thereof. Accordingly, the scope of the invention is intended to be limited only by the scope of the appended claims.

What is claimed is:

1. A computer I/O device with a voice I/O unit comprises:
an I/O device having a capability of either a mouse, a keyboard or other computer peripheral devices, and
a voice I/O unit,
wherein said I/O device is coupled with said voice I/O unit through a hardware or software configuration to enable or disable said voice I/O unit or to adjust the sound volume thereof.

2. The computer I/O device with a voice I/O unit of claim 1, wherein said computer I/O device works with an instant messenger to conduct online communications.

3. The computer I/O device with a voice I/O unit of claim 1, wherein said voice I/O unit integrates with an I/O interface to form a single transmission interface for coupling with a computer.

4. The computer I/O device with a voice I/O unit of claim 3, wherein said transmission interface is a wired transmission interface.

5. The computer I/O device with a voice I/O unit of claim 4, wherein said wired transmission interface is USB or IEEE 1394.

6. The computer I/O device with a voice I/O unit of claim 3, wherein said transmission interface is a wireless transmission interface.

7. The computer I/O device with a voice I/O unit of claim 6, wherein said wireless transmission interface is Bluetooth or Infrared.

8. The computer I/O device with a voice I/O unit of claim 1, wherein said computer I/O device is a mouse having a motion sensing capability at a bottom thereof, said mouse working with a software or a hardware to provide a speaker phone capability or a handset capability when an incoming call is present, said voice I/O unit automatically adjusting the sound volume according to whether said computer I/O device is in a speaker phone or a handset configuration.

9. The computer I/O device with a voice I/O unit of claim 1, further comprising a switch having a software or a hardware interface for selecting said voice I/O unit or computer I/O device, or both.
